(19) United States
(12) Patent Application Publication
(10) Pub. No.: US 2010/0197316 A1
(43) Pub. Date: Aug. 5, 2010

(54) RADIO TRANSMITTING/RECEIVING METHOD AND RADIO COMMUNICATION TERMINAL

(75) Inventors: Takahisa Aoyama, Kanagawa (JP); Akito Fukui, Kanagawa (JP); Daiji Ido, Arlington, VA (US)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/665,216

(22) PCT Filed: Jun. 18, 2008
(86) PCT No.: PCT/JP2008/001568

§ 371 Date: Dec. 17, 2009

(30) Foreign Application Priority Data
Jun. 19, 2007 (JP) 2007-161965

(51) Int. Cl. H04W 72/04; H04B 17/00

(52) U.S. Cl. 455/452.1; 455/67.13

(57) ABSTRACT

A radio communication terminal capable of efficiently performing DRX or DTX. The terminal comprises an on-period determining section (106) and a DRX/DTX control section (108). The on-period determining section (106) determines a subframe at the beginning of a first on-period within a DRX period by matching it with the subframe during which a CQI report is performed, determines the subframe apart by an integral multiple of the DRX cycle from the determined subframe at the beginning of the first on-period as the subframe at the beginning of the first on-period, and determines the subframes within the first on-period including each sub frame at the beginning of the first on-period as those in an on-period state. The DRX/DTX control section (108) controls the DRX of a receiving section (101) and the DTX of a transmitting section (109) according to the subframe in an on-period state inputted from the on-period determining section (106).

### TECHNICAL FIELD

The present invention relates to a radio transmission and reception method and a radio communication terminal apparatus.

### BACKGROUND ART

According to the 3GPP UMTS system release 1999 and its equivalent that have been standardized, there are roughly two states that are subject to state management in the RRC (Radio Resource Control) of terminals (see Non-Patent Document 1). These are the two RRC states: the RRC connected mode and the RRC idle mode. The RRC connected mode is further divided into four states, that is, CELL_DCH, CELL_FACH, CELL_PCH and URA_PCH.

CELL_DCH refers to a state in which a radio communication terminal apparatus (hereinafter, abbreviated as “terminal”) and a radio communication base station apparatus (hereinafter, abbreviated as “base station”) are connected via a dedicated channel and in which substantial power is consumed because transmission and reception go on a constant basis. Furthermore, since a dedicated channel is set up, transmission and reception of large data are possible.

CELL_FACH refers to a state in which transmission and reception between a terminal and base station are carried out using a shared channel, and in which less power is consumed than in CELL_DCH because transmission and reception are carried out only when necessary. Furthermore, since a plurality of terminals carry out transmission and reception using limited shared channels, CELL_FACH is not suitable for transmission and reception of large data.

CELL_PCH refers to a state in which a terminal waits for generation of new data or a call from a base station and in which no data is transmitted or received. Moreover, setup information for earlier services and so on are left. Furthermore, move within a cell involves only waiting at discontinuous reception (DRX) intervals, so that no data is transmitted or received and little power is consumed.

URA_PCH refers to a state in which a terminal waits for generation of new data or a call from a base station and in which no data is transmitted or received. Moreover, setup information for earlier services and so on are left. Furthermore, move within the URA (UTRAN Registration Area) (a plurality of cell groups) involves only waiting, so that no data is transmitted or received and little power is consumed.

The RRC idle mode refers to a state in which a terminal waits for generation of new data or a call from a base station and in which no data is transmitted or received. Setup information for earlier services and so on are not left. Furthermore, move within the RA (Routing Area) or LA (Location Area) (a plurality of cell groups) involves only waiting, so that no data is transmitted or received and little power is consumed.

The network side allows a terminal to transition to suitable RRC states that match the situation of the terminal using the above RRC states, and, by this means, makes possible reduced power consumption of the terminal and effective use of radio resources.

However, this system involves the following big problems. The first problem is that, since there are many states, terminals and the network both require complex control, and the second problem is that, since state transition is carried out using RRC messages and is time-consuming, it is difficult to make transitions frequently.

Therefore, studies are currently underway for efficient terminal state management under LTE (Long Term Evolution)/SAE (System Architecture Evolution), whose standardization is in progress by the 3GPP, aiming not to divide the RRC connected mode into the above four states (see Non-Patent Document 2).

In the RRC connected mode, when data is not present, discontinuous reception (DRX) and discontinuous transmission (DTX) are used to save power consumption. Furthermore, when DRX/DTX is set up, a MAC (Medium Access Control) message (“MAC message”) may be used.

Thus, unlike the above-described UMTS, LTE/SAE can set up DRX using a MAC message. As shown in FIG. 1, LTE/SAE defines a DRX interval called “DRX cycle” and a period called “ON duration” during which receiving processing can be carried out in the DRX interval. Furthermore, as shown in FIG. 2, in LTE/SAE, a radio frame may be formed with ten subframes. Furthermore, each radio frame is managed based on a number called “system frame number” (SFN).

Non-Patent Document 1: 3GPP, TS25.331, 3rd Generation Partnership Project, Technical Specification Group Radio Access Network, Radio Resource Control (RRC), Protocol Specification.

Non-Patent Document 2: 3GPP, TS25.813, 3rd Generation. Partnership Project, Technical Specification Group Radio Access Network, Evolved Universal Terrestrial Access (E-UTRA) and Evolved Universal Terrestrial Radio Access Network (E-UTRAN), Radio interface protocol aspects.

### DISCLOSURE OF INVENTION

### Problems to be Solved by the Invention

However, when a base station sends a DRX command to a terminal using a MAC message, there is a problem that the base station might mistake a NACK signal from the terminal for an ACK signal.

It is an object of the present invention to provide a radio transmission and reception method and a radio communication terminal apparatus for efficiently carrying out DRX or DTX.

### Means for Solving the Problem

The radio transmission and reception method of the present invention for carrying out discontinuous transmission or discontinuous reception include: a channel quality indicator transmitting step of transmitting a channel quality indicator; a first ON duration determining step of determining a first ON duration during which transmission or reception by the discontinuous transmission or discontinuous reception is possible, based on transmission time of the channel quality indicator; and a discontinuous transmission and reception control step of controlling discontinuous transmission or discontinuous reception according to the first ON duration.

The radio communication terminal apparatus of the present invention adopts a configuration including: a channel quality indicator transmitting section that transmits a channel quality indicator; an ON duration determining section that determines a first ON duration of discontinuous transmission or discontinuous reception, based on transmission time of the channel quality indicator; and a discontinuous transmission/reception control section that controls discontinuous transmission or discontinuous reception according to the first ON duration.

### ADVANTAGEOUS EFFECTS OF INVENTION

The present invention makes possible efficient DRX or DTX.

### BRIEF DESCRIPTION OF DRAWINGS

FIG. 1 illustrates a DRX cycle;

FIG. 2 illustrates a configuration of a radio frame and sub frames;

FIG. 3 is a block diagram showing a configuration of a terminal according to Embodiment 1 of the present invention;

FIG. 4A illustrates DRX semi-static information according to Embodiment 1 of the present invention;

FIG. 4B illustrates DRX dynamic information according to Embodiment 1 of the present invention;

FIG. 5 illustrates a terminal operation according to Embodiment 1 of the present invention;

FIG. 6 illustrates an effect of a first period according to Embodiment 1 of the present invention;

FIG. 7 illustrates an effect of a second period according to Embodiment 1 of the present invention;

FIG. 8 illustrates a terminal operation according to Embodiment 1 of the present invention;

FIG. 9 is a block diagram showing a configuration of a terminal according to Embodiment 2 of the present invention;

FIG. 10 illustrates a terminal operation according to Embodiment 2 of the present invention;

FIG. 11 is a block diagram (example in which IMSI is used) showing a configuration of a terminal according to Embodiment 3 of the present invention;

FIG. 12 is a block diagram (example in which C-RNTI is used) showing another configuration of the terminal according to Embodiment 3 of the present invention; and

FIG. 13 is a block diagram showing a configuration of a terminal according to Embodiment 4 of the present invention.

### BEST MODE FOR CARRYING OUT THE INVENTION

Hereinafter, embodiments of the present invention will be explained in detail with reference to the accompanying drawings. However, components having identical functions among embodiments will be assigned the same reference numerals and overlapping explanations will be omitted. Furthermore, in the following explanations, a terminal starts DRX according to a DRX command from a base station or according to a timer the terminal manages by itself. Furthermore, in the following explanations, suppose an ON duration in normal DRX operation during DRX will be referred to as a “first ON duration” and an ON duration in which error recovery can be performed, which is an operation for recovery when an error occurs, will be referred to as a “second ON duration.”

### Embodiment 1

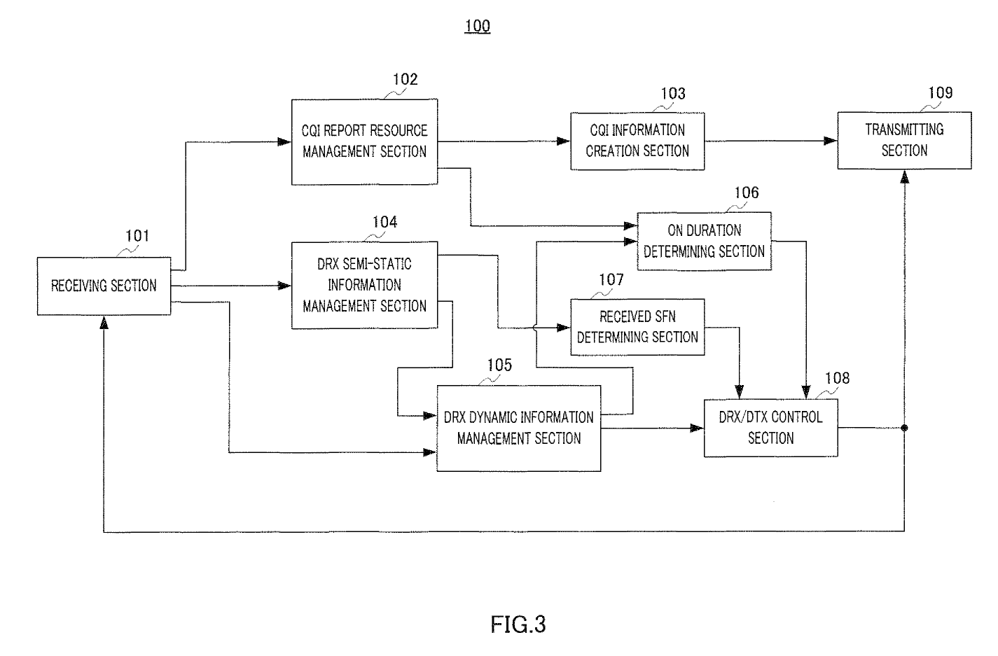

FIG. 3 is a block diagram illustrating a configuration of terminal 100 according to the present embodiment. In terminal 100 shown in FIG. 3, receiving section 101 receives a signal transmitted from a base station, and, in the signal received, outputs CQI (Channel Quality Indicator) report information to CQI report resource management section 102, DRX semi-static information to DRX semi-static information management section 104 and DRX dynamic information to DRX dynamic information management section 105. Furthermore, receiving section 101 determines whether or not to perform receiving processing according to the control by DRX/DTX control section 108, which will be described later.

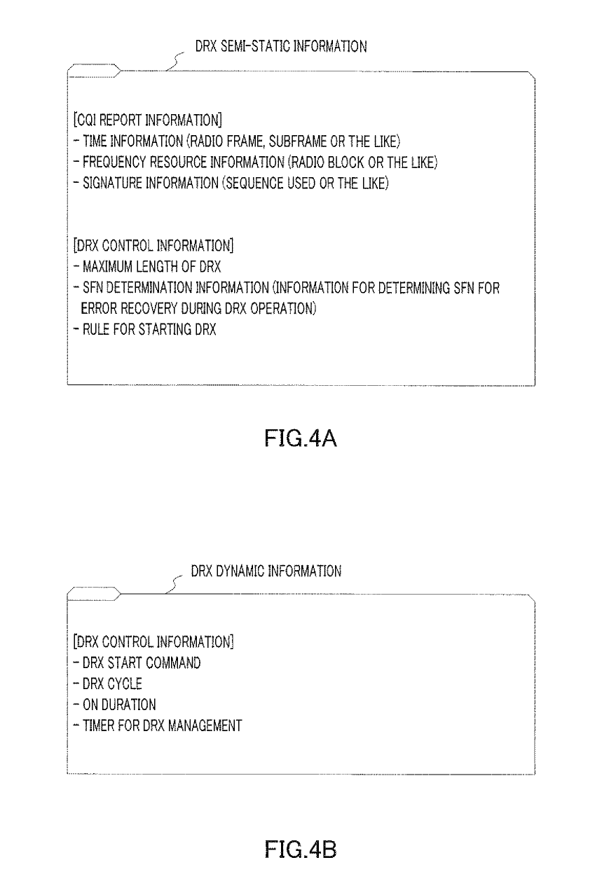

Here, as shown in FIG. 4A, the control information used to control DRX includes CQI (Channel Quality Indicator) report information and DRX control information as DRX semi-static information, which may be transmitted from the base station using an RRC message taking into account the reliability. Here, the CQI report information is managed in CQI report resource management section 102 and the DRX control information is managed in DRX semi-static information management section 104. On the other hand, as shown in FIG. 4B, DRX control information is DRX dynamic information, and MAC messages might be used taking into account the frequency of transmission and reception between terminal 100 and the base station. Control information used to control DRX may be either transmitted from the base station per DRX command or may be set in advance in terminal 100. This information is managed in DRX dynamic information management section 105.

To be more specific, CQI report information includes time information for determining the time for CQI reporting, frequency domain resource information for CQI reporting, and other information for CQI reporting such as signature information used upon reporting CQI. On the other hand, DRX control information includes the maximum DRX interval length that is possible when DRX is used, SFN determination information for determining SFN's in which error recovery is possible during DRX operation, rules for when the terminal voluntarily starts DRX, and so on. On the other hand, DRX dynamic information includes DRX start command information indicating a command for starting DRX, a DRX cycle, an ON duration period, a timer for managing the start of DRX and so on.

Here, as for the error recovery scheme, the base station may report the DRX setup to the terminal or end DRX at times of second ON durations, to allow the base station to perform error recovery.

CQI report resource management section 102 manages the CQI report information received as input from receiving section 101. CQI report resource management section 102 then outputs the CQI report information managed, to CQI information creation section 103, and outputs information about the radio frames and subframes subject to CQI reporting, out of the time information shown in the CQI report information, to ON duration determining section 106.

CQI information creation section 103 creates CQI information based on the CQI report information received as input from CQI report resource management section 102. CQI information creation section 103 then outputs the created CQI information to transmitting section 109.

DRX semi-static information management section 104 manages the DRX semi-static information received as input from receiving section 101. DRX semi-static information management section 104 then outputs SFN determination information as information related to the second ON duration in which error recovery is possible, to received SFN determining section 107, and outputs the DRX control information other than the SFN determination information to DRX dynamic information management section 105, out of the DRX control information in the DRX semi-static information managed.

DRX dynamic information management section 105 manages the DRX dynamic information received as input from receiving section 101 and the DRX control information other than the SFN determination information received as input from DRX semi-static information management section 104. Furthermore, DRX dynamic information management section 105 manages timer start, expiration and stop, to manage the start of DRX by the terminal. DRX dynamic information management section 105 then outputs the DRX dynamic information managed, to DRX/DTX control section 108, and outputs the DRX start command information, DRX cycle and first ON duration period of the DRX dynamic information managed, to ON duration determining section 106.

ON duration determining section 106 determines the radio frames and subframes to be in the ON duration state, based on the information about the radio frame and subframe information for CQI reporting received as input from CQI report resource management section 102 and the DRX start command information, DRX cycle and first ON duration period received as input from DRX dynamic information management section 105. To be more specific, when DRX start command information is received as input, ON duration determining section 106 determines the subframe subject to CQI reporting first in the radio frame after DRX start command, as the subframe to be positioned at the beginning of a first ON duration, based on subframes subject to CQI reporting. Furthermore, ON duration determining section 106 determines subframes integer multiples of the DRX cycle apart from the determined subframe as subframes to be positioned at the beginning of first ON durations. ON duration determining section 106 then determines subframes corresponding to the first ON duration period including each subframe to be positioned at the beginning of a first ON duration, as subframes to be in the ON duration state. ON duration determining section 106 then outputs first ON duration information indicating the determined radio frames and subframes to be in the ON duration state and subframe information subject to CQI reporting to DRX/DTX control section 108.

Received SFN determining section 107 determines the SFN's of the radio frames to which the second ON durations belong during DRX operation, based on the SFN determination information received as input from DRX semi-static information management section 104. For example, when it is assumed that the period of the SFN's to which second ON durations belong during DRX operation is 512 and in one SFN period a second ON duration belongs to the sixth SFN, received SFN determining section 107 determines the SFN's where SFN % 512=6, that is, SFN's whose remainder by a division by 512 is 6, as the SFN's of the radio frame to which second ON durations belong. Here, “%” represents modulo operation. That is, in the above example, the SFN's in a radio frame to which second durations belong are determined in order of SFN=6 and 518 (=6+512). Received SFN determining section 107 then outputs the determined SFN's to DRX/DTX control section 108.

DRX/DTX control section 108 functions as a discontinuous transmission/reception control section. To be more specific, DRX/DTX control section 108 controls DRX in receiving section 101 and DTX in transmitting section 109 according to the DRX dynamic information received as input from DRX dynamic information management section 105, first ON duration information received as input from ON duration determining section 106 and subframe information subject to CQI reporting and the SFN's received as input from received SFN determination section 107.

Transmitting section 109 functions as a channel quality indicator transmitting section. Transmitting section 109 determines whether or not to perform transmission processing based on the control from DRX/DTX control section 108, and transmits, when transmission is carried out, CQI information received as input from CQI information creation section 103 to the base station.

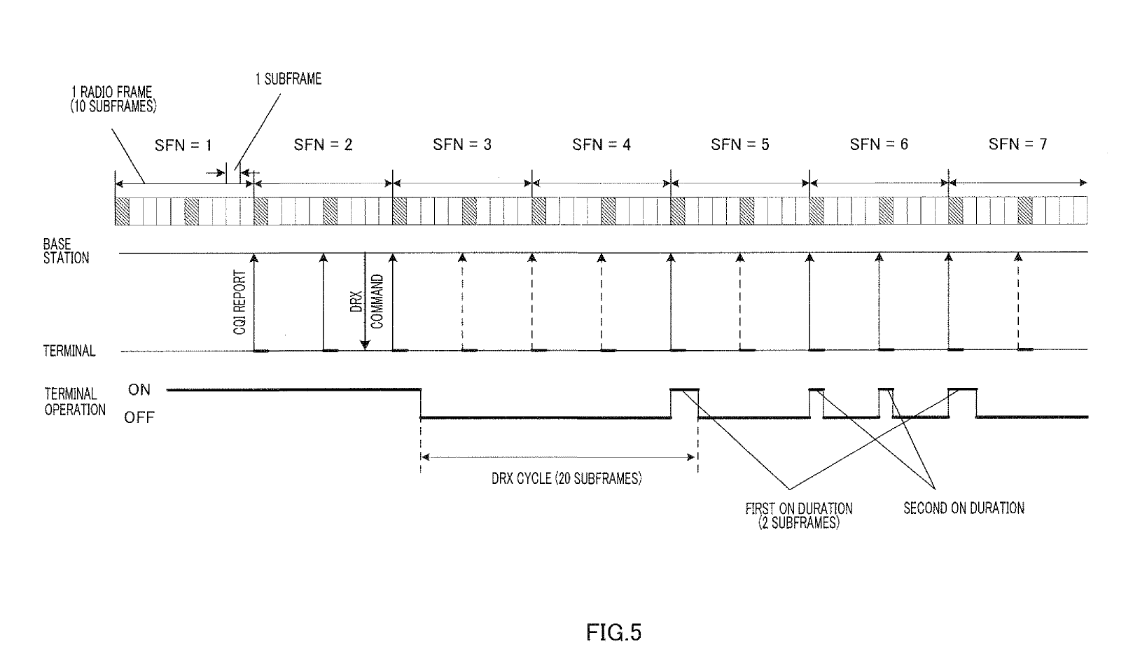

Next, DRX operation will be explained using FIG. 5. In FIG. 5, one radio frame is formed with ten subframes (subframe #0 to subframe #9), and each radio frame is assigned SFN's (SFN=1 to 7 in FIG. 5). Furthermore, suppose the subframes subject to CQI reporting are subframe #0 and subframe #5 in each radio frame. Furthermore, suppose the DRX cycle is two radio frames (2×10 subframes) and the first ON duration is two subframes. Furthermore, as SFN determination information, suppose the period of SFN's to which second ON durations belong is 512 and the SFN to which a second ON duration belongs is the sixth SFN in each period.

As shown in FIG. 5, in the RRC connected mode, the base station transmits an DRX command to terminal 100 using subframe #8 in the radio frame of SFN=2. DRX dynamic information management section 105 then outputs DRX start command information to ON duration determining section 106.

Thus, ON duration determining section 106 determines the earliest subframe after subframe #8 in the radio frame of SFN=2 among the subframes subject to CQI reporting, that is, subframe in the radio frame of SFN=3 as the subframe to be positioned at the beginning of the initial first ON duration. That is, subframe #0 in the radio frame of SFN=3 is the time to start DRX.

As shown in FIG. 5, the DRX cycle is formed with 20 subframes, and therefore ON duration determining section 106 determines the subframe 20 frames after subframe #0 in the radio frame of SFN=3, that is, subframe #0 in the radio frame of SFN=5 as the subframe to be positioned at the beginning of a first ON duration and further determines the subframe 20 frames after subframe #0 in the radio frame of SFN=5, that is, subframe #0 in the radio frame of SFN=7 as the subframe to be positioned at the beginning of a first ON duration.

As shown in FIG. 5, a first ON duration is two subframes, and therefore ON duration determining section 106 determines subframes #0 and #1 in the radio frame of SFN=3, subframes #0 and #1 in the radio frame of SFN=5 and subframes #0 and #1 in the radio frame of SFN=7 as subframes to be set in the first ON duration state.

Next, received SFN determining section 107 determines an SFN where SFN % 512=6 as an SFN to which a second ON duration belongs in a radio frame. That is, received SFN determining section 107 determines SFN=6 shown in FIG. 5 as the SFN in the radio frame to which a second ON duration belongs. Furthermore, the SFN in the radio frame to which a second ON duration belongs next to the radio frame of SFN=6, is SFN=518 (=6+512). Though the present embodiment assumes that the period of SFN's to which second ON durations belong is 512, the period of the SFN's to which second ON durations belong is not limited to 512 and may be adjusted according to the frequency error recovery is performed.

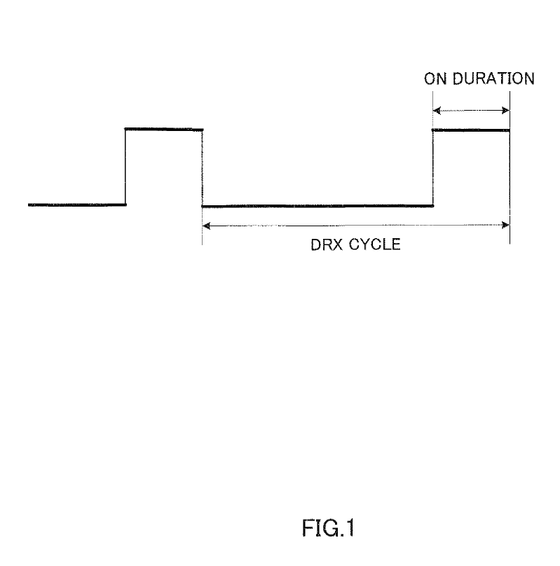

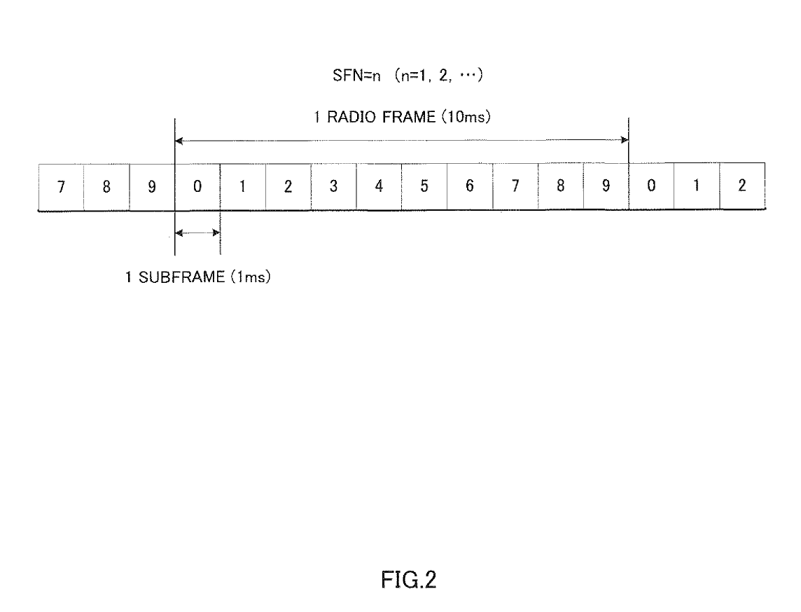

Thus, DRX/DTX control section 108 starts DRX from subframe #0 in the radio frame of SFN=3. To be more specific, as shown in FIG. 5, DRX/DTX control section 108 sets subframes and #1 in the radio frame of SFN=3 in the first ON duration state (terminal operation: ON, that is, active state) and sets the terminal operation in subframe #3 in the radio frame of SFN=3 to OFF, that is, in a sleep state. That is, subframe #3 in the radio frame of SFN=3 becomes the starting position of the DRX cycle shown in FIG. 1. Furthermore, as shown in FIG. 5, DRX/DTX control section 108 sets subframes #0 and #1 in the radio frame of SFN=5 in the first ON duration state (terminal operation: ON) again and also sets subframes #0 and #1 in the radio frame of SFN=7 in the first ON duration state (terminal operation: ON).

Furthermore, for error recovery, DRX/DTX control section 108 sets subframe 40 and subframe #5 subject to CQI reporting in the radio frame of SFN=6 in the second ON duration state (terminal operation: ON).

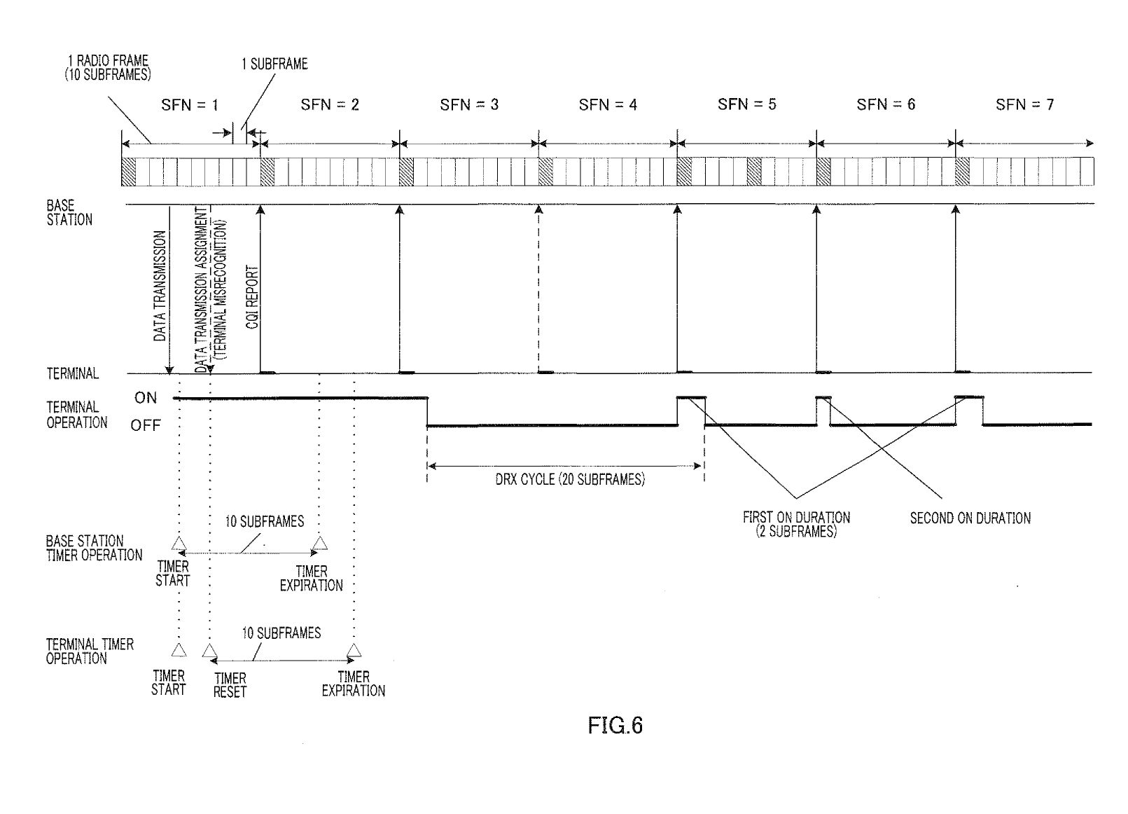

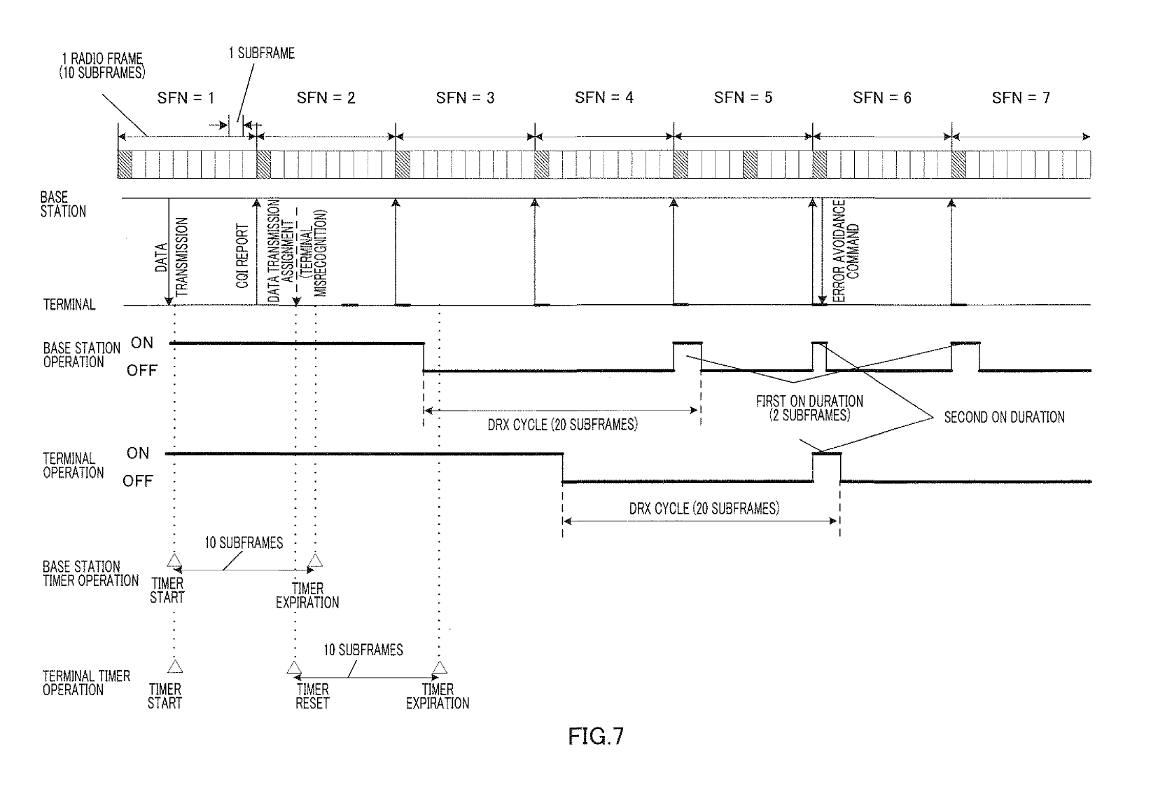

Next, the operation in the case where an error occurs will be explained using FIG. 6 and FIG. 7.

A case of an error that occurs when the terminal starts DRX without waiting for a MAC message due to the absence of data for a certain period of time, will be explained. Here, periods in which data is not present are managed by means of a timer and DRX is started when the timer expires. To be more specific, when a terminal cannot receive any L1/L2 control channel and the base station mistakenly receives noise and such as an ACK signal although the terminal has not transmitted an ACK signal or NACK signal, the base station resets the timer, while the terminal leaves the timer as is. Alternatively, when the base station does not command the terminal on the assignment of data transmission through the L1/L2 control channel but the terminal nevertheless mistakenly receives this as data assignment, the base station leaves the timer as is, whereas the terminal resets the timer. This produces a difference between the timers of the terminal and base station.

First, the effect of determining the first ON duration based on the time to send a CQI report will be explained using FIG. 6. Here, a case will be explained where the base station has not commanded a terminal on assignment of data transmission through the L1/L2 control channel but the terminal nevertheless mistakenly receives this as data assignment. Here, suppose the timer manages the time in units of ten subframes to ensure that there is no transmission/reception of data to start DRX.

As shown in FIG. 6, data is transmitted from the base station to the terminal in subframe 43 in the radio frame of SFN=1. That is the last data. As a result, the terminal and base station start the timers from subframe #4 in the radio frame of SFN=1, which is the next subframe.

Here, in subframe #6 in the radio frame of SFN=1, the base station has not commanded the terminal on the assignment of data transmission through the L1/L2 control channel, but the terminal nevertheless mistakenly determines this as data assignment and resets the timer. Therefore, as shown in FIG. 6, the timer of the base station expires in subframe #4 in the radio frame of SFN=2, whereas the timer of the terminal expires in subframe #6 in the radio frame of SFN=2. However, the time to start DRX processing at the terminal and base station is subframe #0 in the radio frame of SFN=3, which is the time of the next CQI reporting. Therefore, by using the time of the first CQI report after DRX is determined, it is possible to perform DRX operation at the same time even when different timer operations are performed between the terminal and the base station, and therefore there is a difference between the timers of the terminal and the base station.

Next, the effect of using the second ON durations will be explained using FIG. 7. A difference of FIG. 7 from FIG. 6 is that, the operation in which the base station has not commanded the terminal on the assignment of data transmission through the L1/L2 control channel but the terminal nevertheless mistakenly determines this as data assignment, takes place in subframe #2 in the radio frame of SFN=2, immediately before the timer expires. In this case, as shown in FIG. 7, the timer of the base station expires in subframe #3 in the radio frame of SFN=2 as with FIG. 6, and therefore DRX processing is started based on subframe #0 in the radio frame of SFN=3, which is the next, first time of CQI reporting. On the other hand, as shown in FIG. 7, the timer of the terminal expires in sub frame #2 in the radio frame of SFN=3, and therefore DRX processing is started based on subframe #0 in the radio frame of SFN=4, which is the time for the next CQI reporting. Thus, the terminal and the base station perform different DRX operations and the terminal cannot properly receive the information about data assignment from the base station in normal ON durations. However, as shown in FIG. 7, since the radio frame of SFN=6 is set as the radio frame for error recovery, the terminal receives a command from the base station at that time. Therefore, the base station can command the terminal to reset DRX or stop DRX in order to avoid errors.

The present operation is also effective in a case where an error occurs when the base station gives a DRX command to the terminal using a MAC message. To be more specific, there is a case where when the base station mistakes a NACK signal from the terminal for an ACK signal or the terminal cannot receive the L1/L2 control channel, does not recognize data assignment, and further the terminal has not transmitted any ACK signal or NACK signal, but the base station nevertheless mistakenly receives noise as an ACK signal.

Thus, the time to start DRX/DTX is set at the time of CQI reporting. Thus, even when command to start DRX/DTX is received, the terminal does not immediately start DRX/DTX but waits until the DRX/DTX starting time. Thus, even if an error occurs when DRX/DTX is set, since the terminal and the base station are given time to reset DRX/DTX, from the time of a command to start DRX/DTX until the time to start DRX/DTX, it is possible to perform error recovery. Furthermore, even when a difference occurs between the timers of the terminal and base station, DRX/DTX can be started at the same time.

Furthermore, in addition to the normal ON duration (first ON duration) carried out by DRX/DTX, the time of second ON durations in which error recovery is possible, is set separately in advance. This allows the terminal and the base station to reliably keep track of the time to carry out transmission/reception, and therefore DRX/DTX can be reset.

Thus, the present embodiment can determine the first ON durations in DRX/DTX based on the time to transmit a channel quality indicator report such as a CQI report. Furthermore, second ON durations in DRX/DTX are determined based on the frame numbers (SFN's) assigned to each radio frame. Therefore, the present embodiment can use the second ON duration for error recovery and perform DRX or DTX efficiently. Furthermore, the present embodiment can reduce new control information for making an error recovery to a minimum.

Furthermore, according to the present embodiment, the first ON duration includes the time for CQI information transmission. Therefore, since DRX can also be started in accordance with the time for CQI reporting, transmission control for CQI reporting no longer needs to be performed or the frequency of transmission control can be reduced, and therefore power consumption can further be reduced.

Furthermore, the present embodiment limits the second ON durations to the times to transmit CQI information. Therefore, it is possible to reduce the sections that need to be received by the terminal for error recovery and further reduce power consumption.

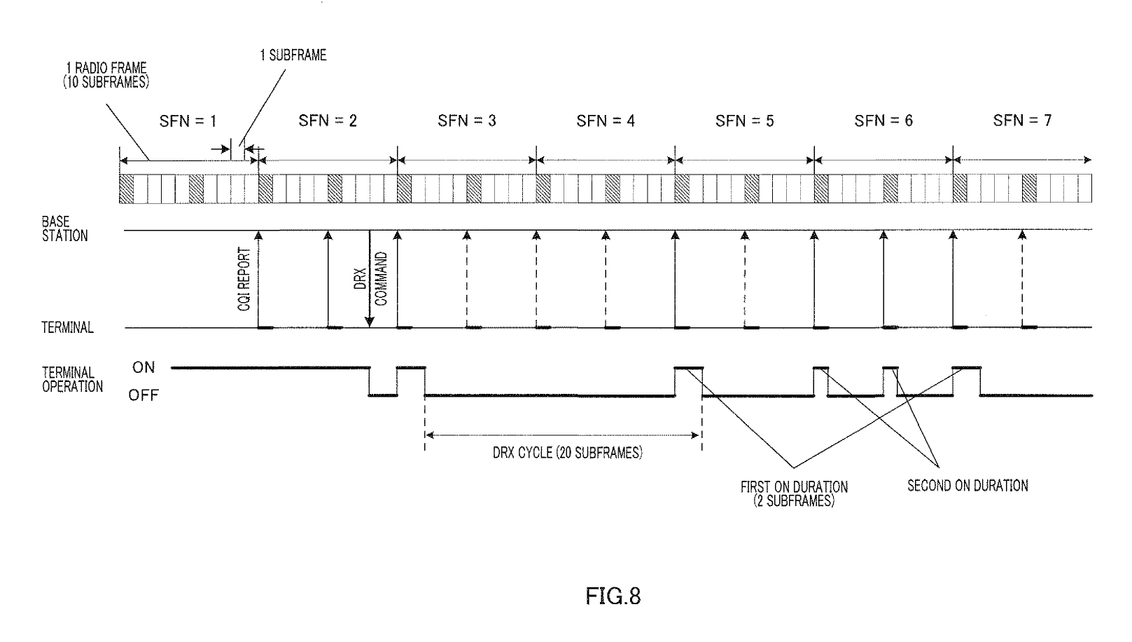

According to the present embodiment, as shown in FIG. 5, terminal 100 continues to carry out reception during a period after a DRX command is received until DRX is started. However, even when there is a difference between the timers of terminal 100 and the base station, recovery is possible at the time of subframe #0 in the radio frame of SFN=3, and therefore terminal 100 may be adapted so as not to carry out transmission/reception in the period from a subframe in which a DRX command is received until the first subframe set in an ON duration state. To be more specific, as shown in FIG. 8, terminal 100 may be adapted so as not to carry out transmission/reception (terminal operation: OFF) after a DRX command is received in subframe #8 in the radio frame of SFN=2, until subframe #0 in the radio frame of SFN=3 in which DRX is started. This makes it possible to start DRX immediately after a DRX command is received and at the same time reduce the probability that DRX cannot be set, perform error recovery, and further reduce power consumption. In this case, information about the radio frame and subframes which are set in the first ON duration state determined by ON duration determining section 106 is outputted to DRX/DTX control section 108 independently of the time the terminal operation is set to OFF for the first time after the DRX command is received.

Furthermore, according to the present embodiment, of the radio frame to which the second ON duration determined according to SFN belongs, a subframe subject to CQI reporting is set in an ON duration state. However, the sub frame to be set in an ON duration state is not limited to a subframe subject to CQI reporting, but all subframes in the radio frame subject to error recovery or any plurality of subframes in the radio frame subject to error recovery may be set in an ON duration state. Furthermore, information about which subframe is to be set in an ON duration state may also be set as DRX semi-static information.

Furthermore, although the present embodiment has not particularly mentioned the roles of RRC and MAC, the present embodiment is implemented by being mounted for RRC and MAC. However, there are no restrictions on how roles are divided and whether or not to use other protocols or the like.

### Embodiment 2

The present embodiment is different from Embodiment 1 in that when determining a subframe to be set in an. ON duration state, the present embodiment uses an SFN of a radio frame to which a second ON duration belongs.

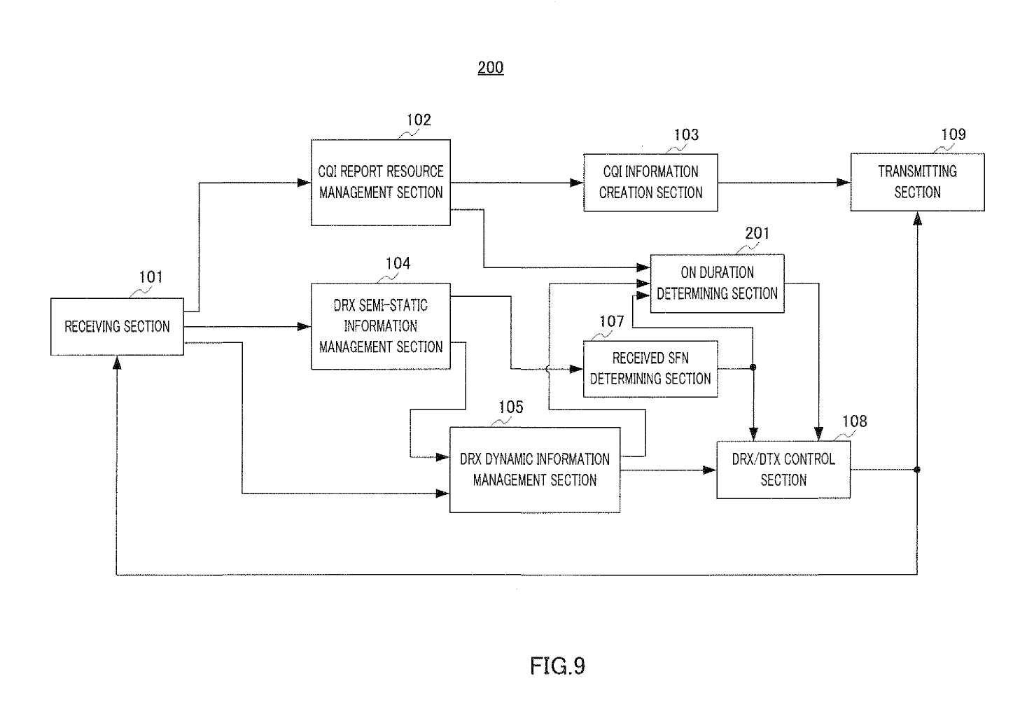

FIG. 9 is a block diagram showing a configuration of terminal 200 according to the present embodiment.

Received SFN determining section 107 outputs the SFN's of radio frames to which second ON durations belong in which error recovery is possible, to ON duration determining section 201.

ON duration determining section 201 determines subframes to be set in an ON duration state based on subframe information received as input from CQI report resource management section 102, DRX start command information received as input from DRX dynamic information management section 105 and SFN's received as input from received SFN determining section 107. To be more specific, when DRX start command information is received as input, ON duration determining section 201 determines the subframe in a radio frame a DRX cycle apart with respect to a radio frame of an SFN to which a second ON duration belongs as a subframe to be positioned at the beginning of the ON duration. First, ON duration determining section 201 calculates an SFN to be set in a first ON duration state from (SFN of the radio frame to which the second ON duration belongs)±DRX cycle/(number of subframes per radio frame)×n (n=1, 2, . . . ). ON duration determining section 201 then determines a subframe having the same number as the subframe number of the subframe to be positioned at the beginning of the initial first ON duration determined based on DRX start command information of the subframes in the radio frame of the SFN to which the calculated radio frame and second ON duration belong as a subframe to be positioned at the beginning of the first ON duration.

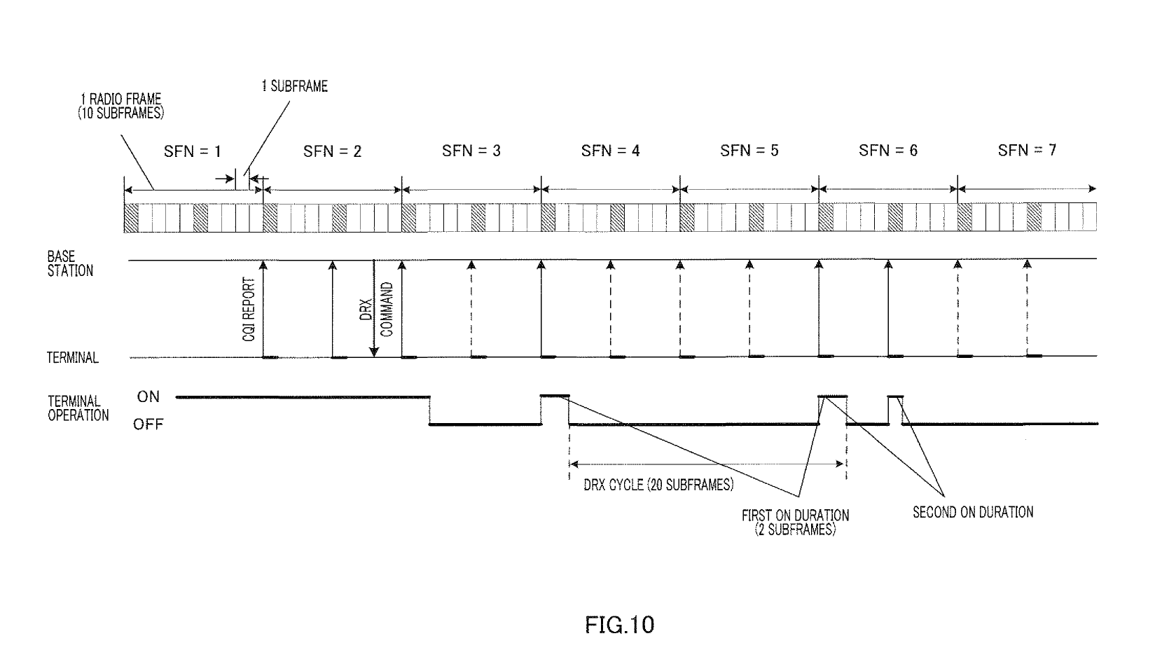

Next, DRX operation will be explained using FIG. 10. In FIG. 10, as with FIG. 5, each radio frame is ten subframes (subframe #0 to subframe #9) and each radio frame is assigned SFN's (SFN=1 to 7 in FIG. 10). Furthermore, suppose subframes subject to CQI reporting are subframe #0 and subframe #5 in each radio frame. Furthermore, suppose the DRX cycle is formed with two radio frames (2×10 sub frames) and the first ON duration is two subframes. Furthermore, as with FIG. 5, error recovery is performed in the radio frame of SFN=6.

As shown in FIG. 10, since a DRX command is transmitted in subframe #8 in the radio frame of SFN=2, ON duration determining section 201 determines subframe #0 in the radio frame of SFN=3 as the subframe to be positioned at the beginning of the initial first ON duration of DRX as with Embodiment 1. Since the SFN of the radio frame to which the second ON duration belongs is 6, ON duration determining section 201 then calculates SFN=4, 8, 10, . . . from 6±(20 subframes/10 subframes)×n (n=1, 2, . . . ). SFNs ahead of SFN=3 of the subframe to be positioned at the beginning of the initial first ON duration are not calculated.

ON duration determining section 201 then determines subframe #0 as the subframe to be positioned at the beginning of each radio frame of the first ON duration out of each subframe of SFN=4, 8, 10, . . . and each subframe in the radio frame of SFN=6.

As shown in FIG. 10, since the first ON duration has two subframes as with Embodiment 1, ON duration determining section 201 determines subframes #0 and #1 in the radio frame of SFN=3, subframes #0 and #1 in the radio frame of SFN=4 and subframes #0 and #1 in the radio frame of SFN=6 as subframes to be set in a first ON duration state. The same will apply to radio frames from SFN=8 onward (not shown).

As shown in FIG. 10, DRX/DTX control section 108 sets subframes #0 and #1 in the radio frame of SFN=3 in an ON duration state (terminal operation: ON), sets subframes #0 and #1 in the radio frame of SFN=4 in an ON duration state (terminal operation: ON), and sets subframes #0 and #1 in the radio frame of SFN=6 in an ON duration state (terminal operation: ON). Furthermore, as shown in FIG. 10, DRX/DTX control section 108 sets subframe #5 in the radio frame of SFN=6 in an ON duration state (terminal operation: ON) for error recovery as with Embodiment 1.

Here, when the terminal operation shown in FIG. 10 is compared with the terminal operation (FIG. 5) in Embodiment 1, the number of subframes in which the terminal operation shown in FIG. 10 is set to ON is smaller than the number of subframes in which the terminal operation shown in FIG. 5 is set to ON. This is because as shown in FIG. 10, in the radio frame of SFN=6 to which the second ON duration belongs, the second ON duration and normal DRX ON duration (first ON duration) are determined so as to overlap each other. Therefore, the present embodiment can reduce power consumption required to perform error recovery during terminal operation.

Thus, according to the present embodiment, since subframes to be set in an ON duration (first ON duration) state during terminal operation partially overlap with subframes to which second ON durations belong, it is possible to minimize the time to carry out transmission/reception. Therefore, the present embodiment can reduce power consumption more than Embodiment 1.

A case where the interval of subframes subject to CQI reporting (five sub frames in FIG. 10) is within the number of subframes (ten subframes in FIG. 10) in one radio frame, that is, a case where a subframe subject to CQI reporting always exists in each radio frame, has been described with the present embodiment. However, the present invention is also applicable to a case where the interval of a subframe subject to CQI reporting is equal to or greater than the number of subframes in one radio frame.

However, cases might occur where no subframe subject to CQI reporting exists in a radio frame to which a second ON duration belongs. Therefore, the base station needs to perform control to make sure CQI reporting is performed in radio frames to which second ON duration belongs. Alternatively, when the terminal receives a setting of not making any CQI report for radio frames to which second ON durations belong, such an operation of requesting the base station to make an appropriate setting using an invalid configuration or the like is also possible.

### Embodiment 3

The present embodiment determines a radio frame to which a second ON duration belongs based on paging information.

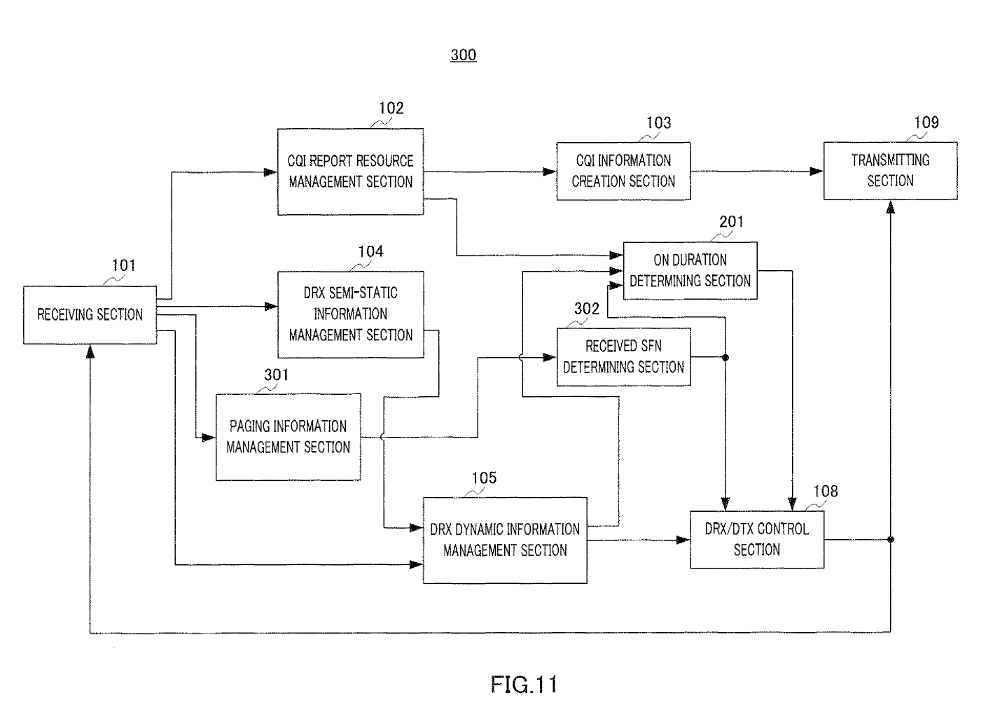

FIG. 11 is a block diagram illustrating a configuration of terminal 300 according to the present embodiment.

In FIG. 11, paging information management section 301 manages paging information indicating information to receive paging. Paging information management section 301 then outputs the paging information to received SFN determining section 302. Here, examples of the paging information include IMSI which is a USIM-specific identifier used for a terminal and DRX interval for receiving paging. The DRX interval is reported from a core network (CN) using an NAS message.

Received SFN determining section 302 determines an SFN of a radio frame subject to error recovery using the paging information received as input from paging information management section 301 in the same way as the method of determining a radio frame for receiving the paging information practiced under UMTS.

To be more specific, received SFN determining section 302 calculates an SFN of a radio frame to which a second ON duration belongs from {(IMSI div k)%(2^{k})}+n*2^{k}. Here, (IMSI div k) means that IMSI is divided by k. The radio frame of the SFN determined here is the same radio frame as a radio frame that should receive paging when the terminal is in an idle mode. Received SFN determining section 302 then outputs the determined SFN to DRX/DTX control section 108.

Thus, according to the present embodiment, since the radio frame for receiving paging is used as the radio frame to which the second ON duration belongs, it is possible to perform error recovery without newly defining the radio frame to which the second ON duration belongs.

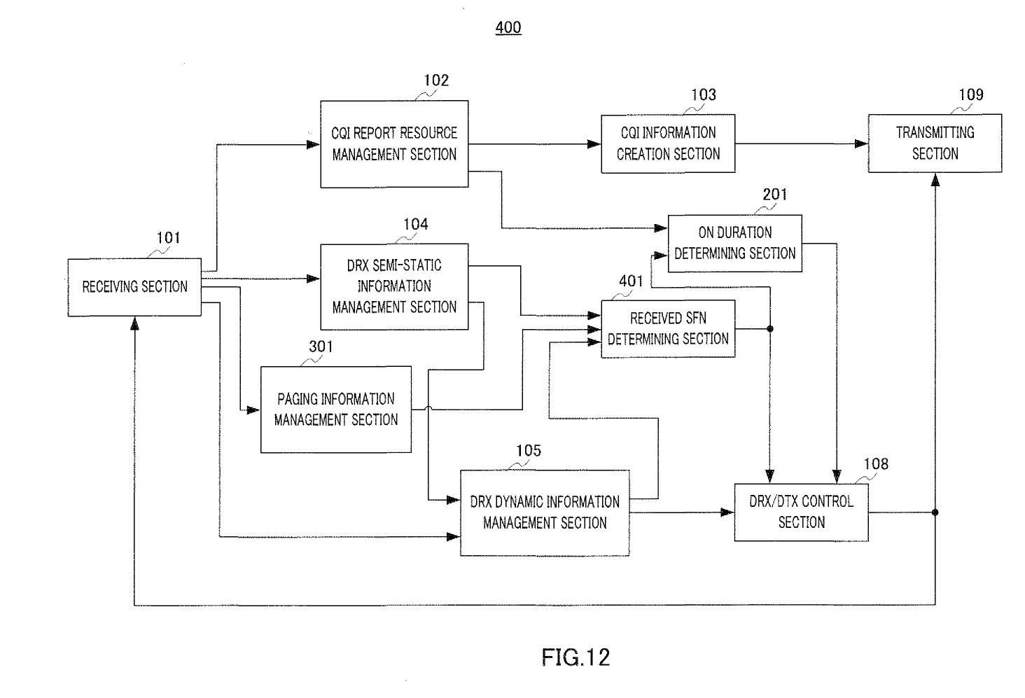

The present embodiment determines a subframe to which the second ON duration belongs using IMSI which is a USIM-specific identifier, but a subframe subject to error recovery may be determined using C-RNTI which is an identifier of a terminal in the cell. To be more specific, in a block diagram of terminal 400 shown in FIG. 12, received SFN determining section 401 calculates a radio frame subject to error recovery from {(C-RNTI div m)%(2^{m})}±n*2^{m}(n=0, 1, 2, . . . ). Here, C-RNTI is a terminal-specific identifier in the cell and 2^{m} is a DRX interval. Here, C-RNTI is managed at a MAC level. That is, security-related problems can be reduced because using C-RNTI allows an error recovery to be made using information other than information such as IMSI that should not be stored in the base station. Instead of the DRX interval (=2^{m}) given from the CN, one determined by the base station may also be used. To be more specific, a maximum DRX interval length of the DRX control information received as input from DRX semi-static information management section 104 may be used or may be separately transmitted to the terminal as DRX control information.

The DRX interval may be changed by a service executed by the terminal. Therefore, the base station may assign the DRX interval to the terminal when a channel is set, the DRX interval may be set for each service in advance or the DRX interval for each service may be broadcast in advance.

Furthermore, UMTS determines a radio frame for receiving a PICH (Paging Indicator CH) to further reduce radio frames that should be received by the terminal in addition to the determination of a radio frame for receiving paging. The present embodiment may also determine a radio frame to which a second ON duration belongs based on the method of determining a radio frame for receiving a PICH under UMTS. To be more specific, received SFN determining section 302 (FIG. 11) determines a radio frame to which the second ON duration belongs from (IMSI div 8192) % Np. Here, Np is the number of PICHs per radio frame and Np is received as broadcast information. This also allows the terminal to determine the time of the second ON duration without using the time to perform CQI reporting.

The above embodiment has been explained based on an operation under UMTS as a paging operation. However, the present invention is also applicable to a scheme whereby a paging location is determined using a different method because the time to receive paging is only defined as a radio frame for error recovery.

### Embodiment 4

The present embodiment determines a radio frame to which a second ON duration belongs using paging information and determines a subframe for CQI reporting as well.

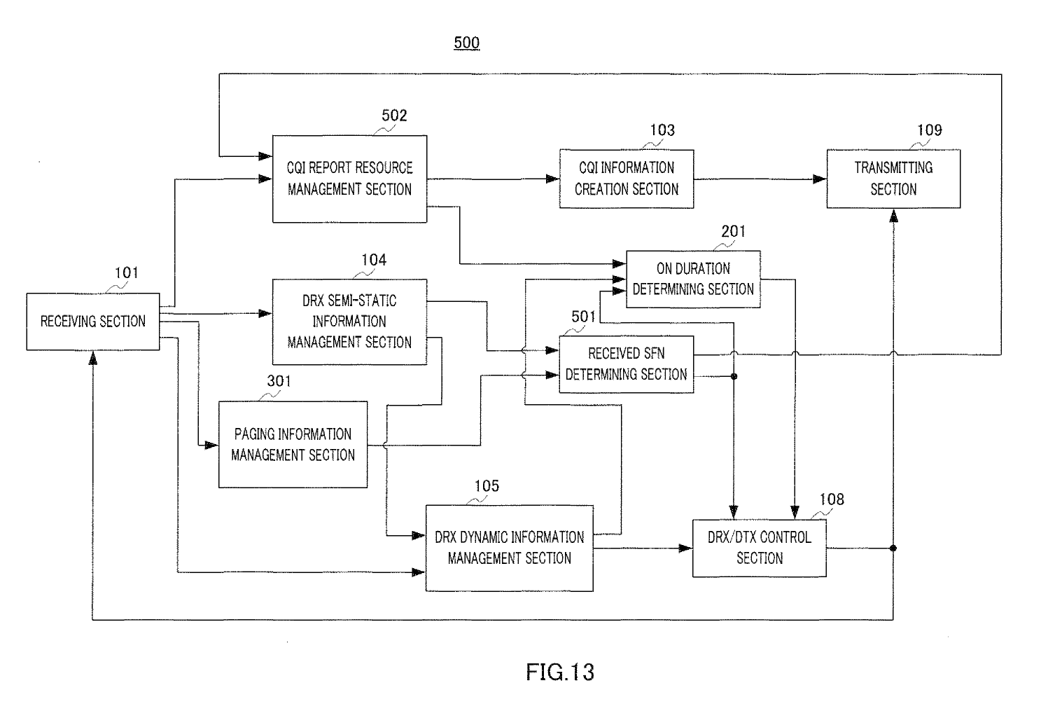

FIG. 13 is a block diagram illustrating a configuration of terminal 500 according to the present embodiment.

In terminal 500 shown in FIG. 13, received SFN determining section 501 functions as a channel quality indicator transmission time determining section. Received SFN determining section 501 receives paging information from paging information management section 301 and receives a subframe interval of a CQI report from DRX semi-static information management section 104. Received SFN determining section 501 then determines the SFN's of radio frames to which second ON durations belong using paging information as with Embodiment 3. Furthermore, received SFN determining section 501 determines a subframe subject to CQI reporting in each radio frame using paging information and subframe interval of the CQI report. To be more specific, received SFN determining section 501 calculates a subframe subject to CQI reporting from C-RNTI % N_{subframe}. Here, C-RNTI is a terminal-specific identifier in a cell and N_{subframe} is the number of subframes in one radio frame. When, for example, C-RNTI is 13, N_{subframe} is 10 and the subframe interval of the CQI report is five subframes, C-RNTI % N_{subframe}=3 results. Therefore, received SFN determining section 501 determines subframe #3 as the subframe subject to CQI reporting. Furthermore, since the subframe interval of the CQI report is five subframes, received SFN determining section 501 further determines subframe #8 (=3+5) as the subframe subject to CQI reporting. Received SFN determination section 501 then outputs the determined SFN to DRX/DTX control section 108 and ON duration determining section 201 and outputs the determined subframe subject to CQI reporting (subframe #3 and subframe #8 in the above example) to CQI report resource management section 502.

CQI report resource management section 502 manages the subframe received as input from received SFN determining section 501 and outputs the subframe subject to CQI reporting to CQI information creation section 103 and ON duration determining section 201.

Even when there is no subframe information subject to CQI reporting, the present embodiment can determine radio frames to which second ON durations belong using paging information without providing new control information and determine subframes subject to CQI reporting.

Embodiments of the present invention have been explained so far.

The embodiments above determine the subframes to be set in an ON duration state for error recovery, but, when the terminal confirms that no error has occurred, no second ON duration for error recovery needs to be set. To be more specific, the base station which has received a CQI report from the terminal during terminal operation can detect whether or not an error has occurred. Therefore, when no error has occurred, the base station takes no action at the time of error recovery. Therefore, when no signal is received from the base station at the time of error recovery, the terminal may be adapted so as not to make subsequent error recoveries. This allows the terminal to suppress unnecessary power consumption.

Furthermore, when a DRX cycle is shorter than a threshold, the embodiments above need not set subframes to be set in an ON duration state for error recovery. Since the frequency with which a short DRX cycle is set in an ON duration state is high, an error recovery can be made during an ON duration of a normal terminal operation, that is, first ON duration. On the other hand, when the DRX cycle is longer than the threshold, settings similar to those in the embodiments above may be made or only subframes to be set in an ON duration state for error recovery may be set. The threshold may be set for each terminal as DRX semi-static information or may be broadcast as broadcast information according to different services.

Furthermore, even a subframe subject to CQI reporting is subjected to receiving processing during terminal operation. However, when a DRX cycle is long, that is, when the interval at which transmission/reception is carried out is long, CQI reporting may not be performed. Therefore, in the embodiments above, a subframe to be set in an ON duration state for error recovery may not be set when the DRX cycle is shorter than a threshold, that is, when CQI reporting is performed, whereas when the DRX cycle is longer than the threshold, that is, only when no CQI reporting is performed, a setting similar to that in the embodiments above is made and only a subframe to be set in an ON duration state for error recovery may be set. This allows the time to set an ON duration state for error recovery to be reduced. The threshold may be set as DRX semi-static information for each terminal or may be broadcast as broadcast information according to different services.

The embodiments above may not be used when the base station explicitly commands DRX operation but may be used only when DRX operation is performed using a timer of the terminal. This is effective in such a case where a signal has sufficiently high reliability when the base station explicitly commands DRX operation.

Furthermore, the embodiments above may also simultaneously set CQI reporting using a signal when the base station explicitly commands DRX operation. In such a case, the terminal performs DRX operation based on the setting of the newly received CQI report. However, since the terminal may not have correctly received the CQI reporting setting, the base station needs to operate so that the terminal can operate any time before or after the setting.

Although cases have been described with the embodiments above where the present invention is configured by hardware, the present invention may be implemented by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC”, “system LSI”, “super LSI”, or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-161965, filed on. Jun. 19, 2007, including the specification, drawings and abstract, is incorporated herein by reference in its entirety.

### INDUSTRIAL APPLICABILITY

The radio transmission and reception method and radio communication terminal apparatus according to the present invention make possible efficient DRX or DTX, and are applicable to, for example, a mobile radio communication system.

1. A radio transmission and reception method for carrying out discontinuous transmission or discontinuous reception, comprising:
a channel quality indicator transmitting step of transmitting a channel quality indicator;
a first ON duration determining step of determining a first ON duration, during which transmission or reception by the discontinuous transmission or discontinuous reception is possible, based on a transmission time of the channel quality indicator; and
a discontinuous transmission and discontinuous reception control step of controlling discontinuous transmission or discontinuous reception according to the first ON duration.

2. The radio transmission and reception method according to claim 1, further comprising a second ON duration determining step of determining a second ON duration of the discontinuous transmission or discontinuous reception based on a frame number.

3. The radio transmission and reception method according to claim 2, wherein, in the second ON duration determining step, the second ON duration is determined based on the transmission time of the channel quality indicator.

4. The radio transmission and reception method according to claim 2, wherein the second ON duration is determined based on paging information.

5. The radio transmission and reception method according to claim 3, further comprising a channel quality indicator transmission time determining step of determining the transmission time of the channel quality indicator using an identifier assigned to a terminal on a per cell basis.

6. The radio transmission and reception method according to claim 1, wherein the transmission time of the channel quality indicator is included in the first ON duration.

7. The radio transmission and reception method according to claim 2, wherein the transmission time of the channel quality indicator is included in the second ON duration.

8. A radio communication terminal apparatus comprising:
a channel quality indicator transmitting section that transmits a channel quality indicator;
an ON duration determining section that determines a first ON duration of discontinuous transmission or discontinuous reception based on transmission time of the channel quality indicator; and
a discontinuous transmission and reception control section that controls the discontinuous transmission or discontinuous reception according to the first ON duration.

9. The radio communication terminal apparatus according to claim 8, wherein the ON duration determining section further determines a second ON duration of the discontinuous transmission or discontinuous reception based on a frame number.

10. The radio communication terminal apparatus according to claim 9, wherein the ON duration determining section determines the second ON duration based on the transmission time of the channel quality indicator.

11. The radio communication terminal apparatus according to claim 9, wherein the ON duration determining section determines a radio frame of the second ON duration based on paging information.

12. The radio communication terminal apparatus according to claim 10, further comprising a channel quality indicator transmission time determining section that determines the transmission time of the channel quality indicator using an identifier assigned to a terminal on a per cell basis.

13. The radio communication terminal apparatus according to claim 8, wherein the transmission time of the channel quality indicator is included in the first ON duration.

14. The radio communication terminal apparatus according to claim 9, wherein the transmission time of the channel quality indicator is included in the second ON duration.
